(19) United States
(12) Patent Application Publication
(10) Pub. No.: US 2014/0058711 A1
(43) Pub. Date: Feb. 27, 2014

(54) PREDICTIVE PARKING

(71) Applicant: Christopher L. Scofield, Seattle, WA (US)

(72) Inventor: Christopher L. Scofield, Seattle, WA (US)

(73) Assignee: INRIX, Inc., Kirkland, WA (US)

(21) Appl. No.: 13/591,665

(22) Filed: Aug. 22, 2012

(51) Int. Cl. G06N 7/02; G06G 7/48

(52) U.S. Cl. 703/6; 706/52

(57) ABSTRACT

Among other things, one or more techniques and/or systems are provided for predicting a state of a parking location (e.g., occupied or vacant). A correlation between modeling variables (e.g., weather, proximity to a location, a calendar of events, sensor data, etc.) and a possible state of the parking location may be modeled. The state of a parking location may then be predicted using the model and current values for one or more variables (e.g., used to develop the model). In one embodiment, representations of one or more parking locations may be displayed on a map and may be marked with indicators (e.g., colors) that indicate a likelihood of the respective parking locations having parking availability, or the number of parking spots that are available (e.g., where a parking location may be a parking garage having multiple parking spots), (e.g., yellow indicating low parking availability, green indicating substantial parking availability).

### BACKGROUND

Parking locations (e.g., parking lots, parking garages, street-side parking spots, etc.) may have different levels of availability (e.g., vacancies) at different times. A driver attempting to park near a desired destination may easily find an available parking spot in a parking location (e.g., that is in close proximity to the desired destination) at a first time. However, the same parking location (e.g., parking garage, metered street, etc.) may have few or no available parking spots at a second time. Some parking locations may be monitored (e.g., with sensors), and users may be enabled to know, in real-time, whether a parking location has an available parking spot. For example, a sign may be present at an entrance of a parking garage and may indicate whether the lot is full and/or if there are available/vacant parking spots within the garage. While this information may be useful, it may not help a driver that is not in the immediate vicinity of a monitored parking location, for example.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques are described herein for modeling a correlation associated with a parking location, where a parking location may comprise a single parking spot or multiple parking spots, such as of a parking garage, for example. In one aspect, a modeling variable associated with a first parking location may be received. The modeling variable may comprise a variable that may be used to build a model, and may be based on, for example, a time (e.g., a day, a week, a month, a year, etc.), weather, proximity to one or more locations (e.g., an airport, a stadium, a theater, etc.), and/or a calendar of major events (e.g., national holidays, religious holidays, etc.). Alternatively, or additionally, the modeling variable may be based on, for example, data received from one or more sensors. The one or more sensors may be configured to detect, for example, a state of one or more parking locations (e.g., comprising the first parking location). A state of a parking location may, for example, comprise an indication of whether the parking location is available (e.g., not occupied) or not available (e.g., occupied).

A model of a correlation between the modeling variable and a possible state of the first parking location may be built. That is, a model may be built to comprise an indication of a correlation between the modeling variable that pertains to the first parking location and a possible state of the first parking location. For example, a modeling variable that is based on the proximity of a location to an airport may be correlated with a possible state of the location being occupied. It may be appreciated that merely one or more variables that are highly correlated (e.g., relevant to the possible state of the parking location) may be used to create a model that may be used to predict a (e.g., future) parking state. For example, to build a model using a large dataset of variables, one or more variables that are determined to be highly correlated (e.g., exceeding a threshold level of correlation) with one or more possible states may be kept, while variables that are determined to not be highly correlated (e.g., failing to exceed a threshold level of correlation) may be removed. The remaining variables (that were determined to be highly correlated to one or more possible states) may be used (e.g., in combination) to build the model. In this manner, resources are not unnecessarily consumed in considering less relevant variables.

It may be appreciated that, as used herein (including in the appended claims), “a”, “an” and/or the like are not meant to be interpreted in a limiting manner to mean one, but instead may comprise one or more and/or the like. For example, “a modeling variable” should not be limited to a single modeling variable. Instead, “a modeling variable” may describe one or more modeling variables. Similarly, “a variable,” “a model,” “a correlation,” “a state,” or “a possible state”, etc. should not be interpreted to merely describe a single variable, a single model, a single correlation, a single state, or a single possible state, etc., respectively. Instead, “a variable,” “a model,” “a correlation,” “a state,” or “a possible state”, etc. may describe one or more variables, one or more models, one or more correlations, one or more states, or one or more possible states, etc., respectively, for example.

One or more systems and/or techniques are further described herein for removing unreliable variables from a set of variables that may, for example, be used to predict a parking state of a location. For example, a set of variables comprising a first variable and a second variable may be received. The first variable may be associated with a first parking location (e.g., may be based upon data from a first sensor that monitors whether the first parking location is occupied or vacant), and the second variable may be associated with a second parking location (e.g., may be based upon data from a second sensor that monitors whether the second parking location is occupied or vacant). The first variable may be compared to the second variable (e.g., and/or statistical measures of the second variable). Based on the comparison, the first variable may be removed from the set of variables (e.g., due to a difference between the first variable and the second variable (e.g., the first variable may be removed where the first sensor appears to be broken because data therefrom is rarely received and/or rarely, if ever, indicates a state change of the first parking location whereas data from the second sensor does indicate a state change of the second parking location over time)). It may be appreciated that the second variable may be part of an aggregate of variables (e.g., that are based upon aggregated data from a plurality of sensors associated with a plurality of parking locations near the first and/or second parking locations), and that the first variable may be compared to the aggregate of variables (e.g., and/or statistical measures of the aggregate of the variables).

One or more systems and/or techniques are further described herein for providing a map indicative of one or more parking locations. A map may be provided and may comprise one or more representations of one or more parking locations. At least some of the one or more representations of one or more parking locations may be marked with one or more indicators. In one example, a first indicator corresponding to a first parking location may, for example, comprise a first color (e.g., green), and a second indicator corresponding to a second parking location may comprise a second color (e.g., red). In the example, the first color may indicate that the first parking location is determined to be more likely to be available (e.g., not occupied) than the second parking location.

The following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an exemplary method for modeling a correlation between a modeling variable and a possible state of a parking location.

FIG. 2 is an exemplary method for predicting a state of a parking location.

FIG. 3 is an illustration of an exemplary parking location where a future state may be predicted.

FIG. 4 is an illustration of an exemplary scenario where a predicted future state of a parking location may depend upon proximity of the parking location to one or more locations and/or to weather.

FIG. 5 is an exemplary system for predicting a state associated with a parking location.

FIG. 6 is an exemplary system for predicting a state associated with a parking location.

FIG. 7 is an exemplary system for removing a variable from a set of variables.

FIG. 8 is an exemplary system for removing a variable from a set of variables.

FIG. 9 is an illustration of an exemplary scenario where representations of parking locations on a map are marked based on a likelihood of availability.

FIG. 10 is an illustration of an exemplary computer-readable medium wherein processor-executable instructions configured to embody one or more of the provisions set forth herein may be comprised.

FIG. 11 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Managers of parking locations such as parking lots, parking garages, and/or street-side parking spots may determine information about one or more parking spots in the respective parking locations. In some instances, the determined information may comprise an indication of one or more states of one or more parking spots in the respective parking locations. For example, information determined about a parking location may indicate that a parking spot (e.g., comprised in the parking location) is occupied. In a different example, information determined about a parking location may indicate that a parking spot (e.g., comprised in the parking location) is vacant. Information about one or more parking spots in a parking location may enable a driver of a vehicle to find a vacant parking spot (e.g., within which to park the vehicle). However, it may be appreciated that a second driver that is driving toward the area of the parking location but is still a significant distance (e.g., one or more miles) away may find an indication of one or more states comprised in the information to be inaccurate and/or unreliable, since the one or more states of the parking location could change (e.g., a vacant parking spot could become occupied and/or an occupied spot could become vacant) by the time the second driver arrives at the parking location.

Accordingly, among other things, one or more systems and/or techniques are provided herein for modeling a correlation associated with a parking location. In particular, a modeling variable (e.g., associated with a time, weather, proximity to one or more locations, a calendar of major events, etc.) may be received. The modeling variable may be associated with a first parking location. A correlation may be modeled between the modeling variable and a possible state of the first parking location.

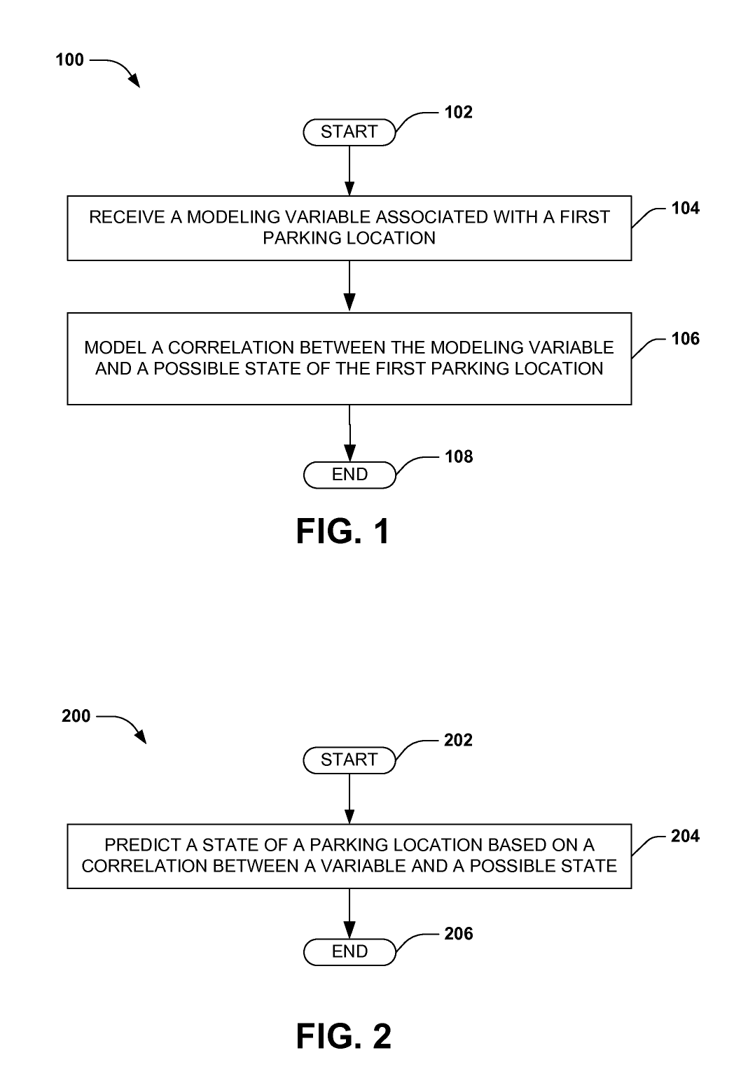

One embodiment of modeling a correlation is illustrated by an exemplary method 100 in FIG. 1. At 102, the method starts. At 104, a modeling variable may be received. The modeling variable may be associated with a first parking location, and/or may be geographically associated with a physical location. In one example, the modeling variable may be based on a time. The modeling variable may, for example, indicate a particular date (e.g., Jun. 13, 2012), a day of the week (e.g., Sunday, Monday, Tuesday, etc.), a month (e.g., January, February, March, etc.), a year (e.g., 2012, 2013, 2014, etc.), etc. The modeling variable may, for example, be based on weather. For example, the modeling variable may indicate cold weather, warm weather, mild weather, rain, snow, a storm, a tornado, or any other condition of weather. The modeling variable may, for example, be based upon a proximity to one or more locations. For example, the modeling variable may indicate proximity to an airport, a stadium, a university, a downtown area, a factory, or a shopping area, etc. The modeling variable may be based upon a calendar of major events. For example, the modeling variable may indicate a temporal proximity (e.g., within a number of minutes, hours, days, weeks, months, etc.) to a national holiday (e.g., New Years Day, Independence Day, Thanksgiving, etc.), a concert, or a sport-related event (e.g., a baseball game), etc. The modeling variable may, for example, be based on data from a sensor. For example, a sensor may detect the presence or absence of one or more vehicles and/or a state of one or more parking locations and provide data (e.g., to a computer) based on the detecting. In the example, the modeling variable may be based on (e.g., real-time) data that the sensor provides. It may be appreciated that a sensor may be configured to provide data based on detection associated with merely one parking spot (e.g., that can be occupied by merely one vehicle) (e.g., an on-street sensor). Alternatively, a sensor may be configured to provide data based on detection associated with more than one parking spot (e.g., in a parking venue comprising more than one parking spot) (e.g., a sensor for a parking garage). It may be appreciated that different modeling variables may be used in combination. For example, a first modeling variable (e.g., that is based on a proximity to one or more locations) may be used in combination with a second modeling variable (e.g., that is based on a temporal proximity to a national holiday). Additionally, one or more modeling variables may be filtered out based upon relevance, for example. That is, respective correlations between different modeling variables and potential parking states (e.g., vacant or occupied) may be determined, and less relevant variables may be removed from consideration. For example, if it is determined that weather conditions have little to no bearing on the parking state of a parking location (e.g., because all parking locations are either indoor or outdoor parking locations and thus afford the same benefits (or lack thereof) regardless of weather conditions), then the modeling variable of weather can be discarded with regard to the parking location (e.g., because drivers' decisions to park in this parking location are not likely to be influenced by weather conditions).

At 106, a correlation may be modeled (e.g., statistically) between the modeling variable and a possible state of the first parking location. The possible state may comprise an indication of whether the first parking location may be occupied, vacant, or partially occupied, for example, when the modeling variable applies. For example, if the modeling variable comprises an indication of cold weather, and the possible state of the first parking location is occupied, then the correlation may be modeled, and may, for example, indicate that when there is cold weather, there is a first probability (e.g., high probability, low probability, etc.) that the first parking location will be occupied. In an example, one or more modeling variables may indicate a change between a first time (e.g., 1 hour ago) and a second time (e.g., now). That is, a modeling variable may have a first value at a first point in time and a second value at a second point in time (e.g., such that a single modeling variable may have different values at the different points in time). Also, the same parking location may be represented by different modeling variables at different points in time. That is, a first modeling variable may be used for a first parking location at a first point in time, while a second modeling variable may be used for the first parking location at a second point in time. At 108, the method ends.

One or more systems and/or techniques are further provided herein for predicting a state of a parking location. In particular, a state (e.g., occupied or vacant) of a parking location may be predicted (e.g., for a current time, for a future time, etc.) based at least in part on a correlation between a variable and a possible state of the parking location. It may be appreciated that a state may be predicted for a first parking location comprising merely a single parking spot. Alternatively, a state may be predicted for a second parking location comprising two or more parking spots.

It may be appreciated that in one embodiment, a state of a second parking location may be predicted (e.g., using a statistical model) based at least in part on a correlation modeled between a modeling variable and a possible state of a first parking location. The second parking location may comprise a parking location different than the first parking location. That is, a prediction for a parking location may be made based on information (e.g., a modeled correlation) associated with another parking location (e.g., that is located near the parking location). For example, responsive to receiving a predicting variable that is associated with Parking Location A (e.g., a time, a date, etc.), a state of Parking Location A may be predicted based upon a modeled correlation between a modeling variable associated with Parking Location B (e.g., a time, a date, etc.) and a possible state of Parking Location B. In an example, the state of Parking Location A may be predicted using the modeling variable associated with Parking Location B if available data associated with Parking Location A is determined to be insufficient and/or Parking Location A is determined to be within a threshold distance of Parking Location B, for example.

One embodiment of predicting a state of a parking location is illustrated by an exemplary method 200 in FIG. 2. At 202, the method starts. At 204, a state of a parking location may be predicted. The prediction may be based on a correlation between a variable and a possible state. The prediction may be for a time after the predicting (e.g., and/or receiving the variable). For example, the prediction may be performed to predict the state of the parking location 2 hours into the future, or 2 hours after the performance of the prediction. Similar to the modeling variable discussed above, the variable may be based on data from a sensor, a time, weather, an (e.g., physical) proximity to a location, and/or an (e.g., temporal) proximity to an event, among other things. In one example, the parking location may correspond to a parking venue (e.g., an outdoor parking lot, a parking garage, one or more city blocks comprising parking spots, etc.). It may be appreciated that in the example, the predicted state of the parking location may indicate a number of parking locations within the parking venue that are vacant (e.g., or occupied). For example, if the parking location corresponds to a parking garage comprising 100 parking spots, the state may indicate that 30 parking spots in the parking garage are vacant. Alternatively, the predicted state of the parking location may indicate a proportion of parking spots within the parking venue that are vacant (e.g., or occupied). For example, if the parking location corresponds to a parking garage comprising 100 parking spots, the state may indicate that 30% of the parking spots in the parking garage are vacant.

In one example, the variable may correspond to one or more vehicles (e.g., a car, a motorcycle, a bus, etc.) driving in an area near the parking location. The one or more vehicles may, for example, comprise a probe vehicle, which may be a vehicle associated with a device (e.g., a mobile phone comprised in the vehicle and/or a computer installed in the vehicle) that may collect information about the vehicle including location data, speed, and/or direction of travel (e.g., to determine traffic information, support intelligent transportation systems, etc.). In the example, the variable may indicate (e.g., based upon real-time GPS data,) that at least some of the one or more vehicles are driving in the area near the parking location (e.g., within a certain distance of the parking location, within a certain number of city blocks of the parking location, etc.) for a period of time. The period of time may be greater than a first threshold, less than a second threshold, and/or greater than the first threshold while also being less than the second threshold. For example, the variable may indicate that a car has driven in an area near the parking location for 20 minutes, which may, for example, be used to predict that the parking location (e.g., and/or one or more other parking locations near the parking location) is occupied and/or not vacant. It may be appreciated that if the variable indicates that the car has been driven around the area near the parking location for three minutes (e.g., before finding a spot to park), the variable may instead, for example, be used to predict that the parking location (e.g., and/or one or more other parking locations near the parking location) is vacant. Alternatively, the variable may indicate that at least some of the one or more vehicles are driving past a same location a number of times. The number of times may be greater than a first threshold, less than a second threshold, and/or greater than the first threshold while also being less than the second threshold. For example, the variable may indicate that a truck has driven around an area near the parking location more than 5 times, which may, for example, be used to predict that the parking location (e.g., and/or one or more other parking locations near the parking location) is occupied and/or not vacant. It may be appreciated that if the variable had indicated that the truck has driven around the area near the parking location only once (e.g., before finding a spot to park), the variable could instead, for example, be used to predict that the parking location (e.g., and/or one or more other parking locations near the parking location) is vacant. Alternatively, the variable may indicate that a number of vehicles are located (e.g., parked) near (e.g., within a distance of) the parking location. The number of vehicles may be greater than a first threshold, less than a second threshold, and/or greater than the first threshold while also being less than the second threshold. For example, the variable may indicate that 8 cars are located and/or parked near the parking location, which may, for example, be used to predict that the parking location (e.g., and/or one or more other parking locations near the parking location) is occupied and/or not vacant.

It may be appreciated that in one embodiment, the variable (e.g., alone) may be determined to not be sufficient to accurately predict the state of the parking location. If the variable is determined to be deficient, a second model (e.g., and/or a second variable) may be used (e.g., in addition to and/or instead of the variable) as a basis for predicting the state of the parking location. For example, if the variable merely indicates that sunny and/or hot weather is associated with the parking location, a determination may be made that the variable alone is not enough to make an accurate prediction and a second model (e.g., and/or a second variable) may also be used (e.g., to compensate for the insufficiency of the variable). In the example, the second model (e.g., and/or the second variable) may comprise and/or be based upon historical data (e.g., not comprising real-time data). The historical data may indicate one or more confirmed and/or predicted states of one or more parking locations at one or more times in the past. For example, a prediction of a state of a parking location at 2 PM on a first day may be based on a variable indicative of a (historical) state of the parking location at 2 PM on one or more days before the first day. One or more variables may be determined to be insufficient (e.g., and/or associated with a poor statistical sampling) to make an accurate prediction based on an identification of less than a threshold number of sources of data (e.g., sensors and/or probe vehicles). For example, if one or more variables are based upon data provided by fewer than five (e.g., or any user-specified number of) probe vehicles, the one or more variables may be determined to be insufficient to make an accurate prediction (e.g., and therefore may be supplemented and/or replaced by historical data). Additionally and/or alternatively, one or more predicted states (e.g., and values associated therewith) may be grouped into one or more bins (e.g., a first bin for vacant parking locations, a second bin for occupied parking locations, a third bin for half-full parking locations, a fourth bin for full parking locations, etc.), which may, for example, be useful for consumption by one or more applications. For example, an application (e.g., executed on a mobile device) may display (e.g., to a user of the mobile device) a map of an area, and may access a first bin for vacant parking locations (e.g., comprising one or more addresses, GPS data and/or coordinates associated with one or more vacant parking locations) to mark, with a first indicator, the parts of the area that comprise vacant parking locations. In the example, the application may access a second bin for occupied parking locations (e.g., comprising one or more addresses, GPS data and/or coordinates associated with one or more occupied parking locations) to mark, with a second indicator, the parts of the area that comprise occupied parking locations. The application may similarly access third, fourth, etc. bins to further populate the map. At 206, the method ends.

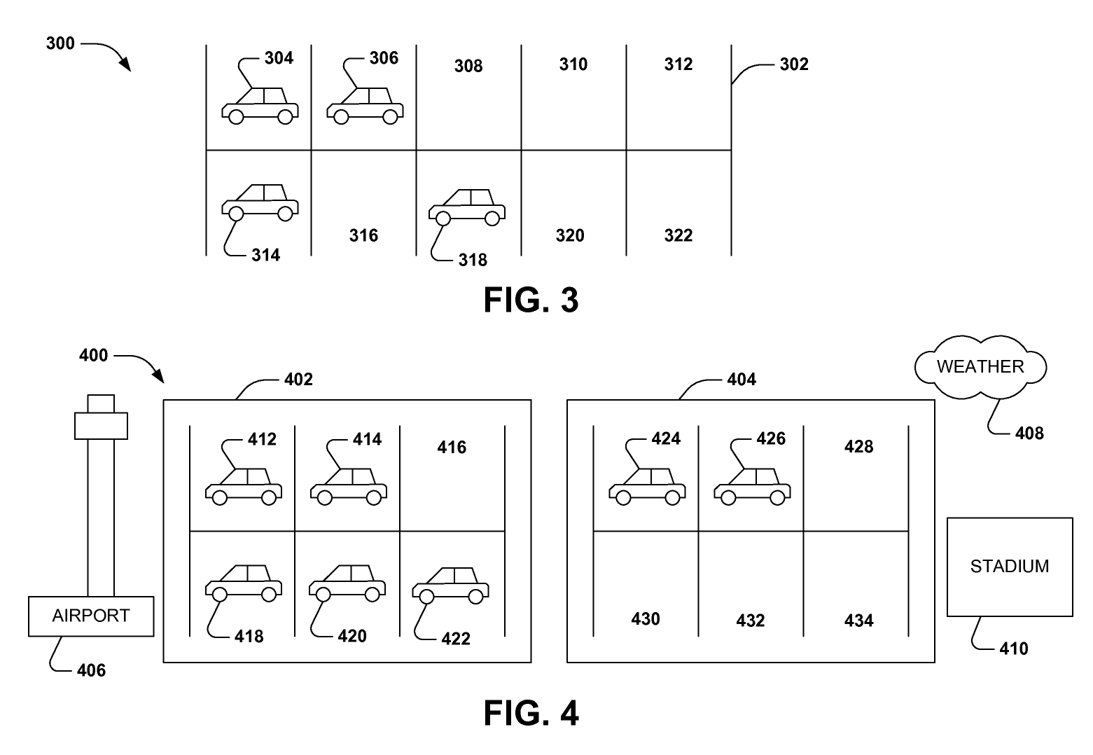

FIG. 3 illustrates an example 300 of one or more parking locations and/or a parking venue. A parking location may, for example, comprise a single parking spot within which a vehicle may be parked, or a plurality of parking spots. A parking spot may be occupied, as illustrated by parking spots 304, 306, 314 and 318. Alternatively, a parking spot may be vacant, as illustrated by parking spots 308, 310, 312, 316, 320 and 322. A plurality of parking spots 304, 306, 308, 310, 312, 314, 316, 318, 320 and 322 may be comprised in a parking location or venue 302 (e.g., an outdoor parking lot, a parking garage, street-side parking meters, etc.).

FIG. 4 illustrates an example 400 of two parking venues or locations. A first parking venue 402 may comprise parking spots 412, 414, 416, 418, 420 and 422. Parking spots 412, 414, 418, 420 and 422 may be occupied, while parking spot 416 may be vacant. A second parking venue 404 may comprise parking spots 424, 426, 428, 430, 432 and 434. Parking spots 424 and 426 may be occupied, while parking spots 428, 430, 432 and 434 may be vacant. In one example, the first parking venue 402 may have a (e.g., close and/or physical) proximity to an airport 406 (e.g., and/or any other location, landmark, etc.). In the example, the second parking venue 404 may have a (e.g., close and/or physical) proximity to a stadium 410 (e.g., and/or any other location, landmark, etc.). In an example, the second parking venue 404 may be associated with weather 408. It may be appreciated that proximity to an airport, proximity to a stadium, and/or weather may affect a demand for parking locations (e.g., by travelers, sports fans, etc.), and may therefore be a basis for one or more variables used to model a correlation and/or predict a state of a parking location, among other things.

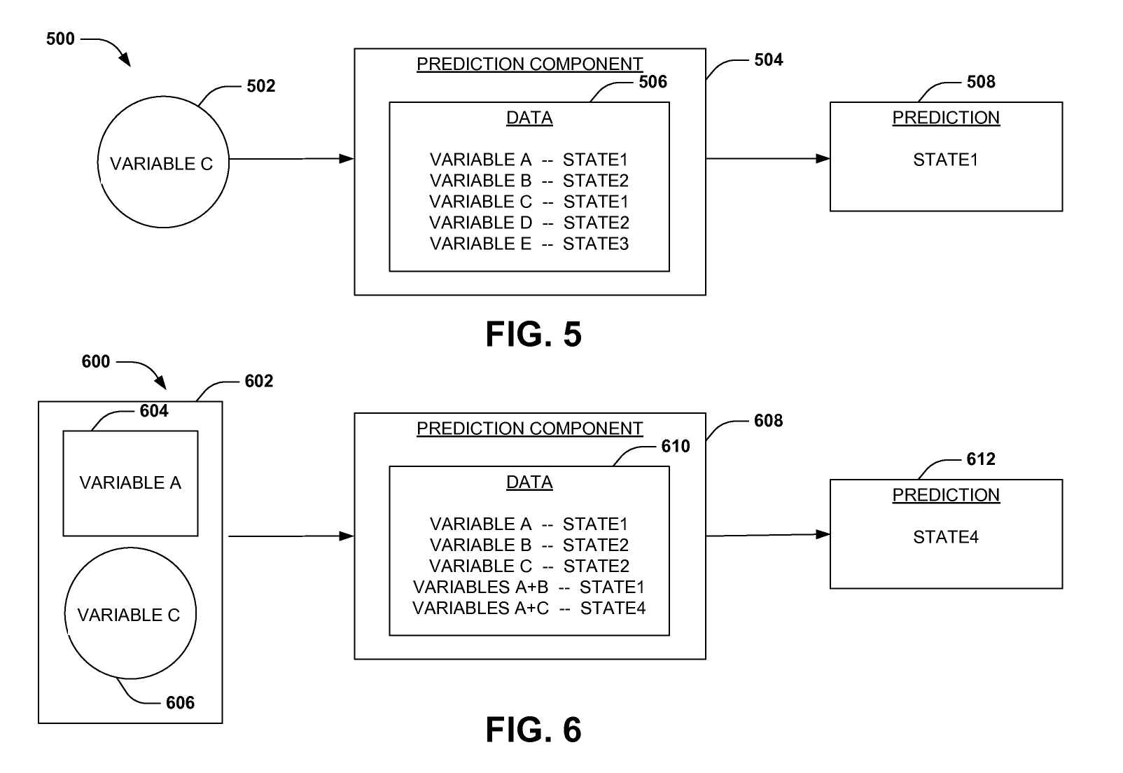

FIG. 5 illustrates an example of a system 500 configured for predicting a state of a parking location. The system 500 may comprise a prediction component 504. The prediction component 504 may have access to data 506, which may comprise one or more indications of one or more correlations between one or more variables and one or more states. The prediction component 504 may be configured to predict a state of a parking location based at least in part on a correlation between a variable and a possible state of the parking location. In one example, prediction component 504 may receive Variable C 502. Prediction component 504 may access data 506 and search for an indication of (e.g., and/or an association with) Variable C. In the example, prediction component 504 may determine that an indication of Variable C in data 506 is associated with a state identified as State1. Prediction component 504 may therefore determine a prediction 508, which may comprise State1. It may be appreciated that the prediction 508 may indicate that for an example parking location associated (e.g., based upon data 506) with Variable C (e.g., rainy weather, proximity near a stadium, etc.), a state of State1 (e.g., vacant, occupied, etc.) may be predicted.

FIG. 6 illustrates an example of a system 600 configured for predicting a state of a parking location. The system 600 may comprise a prediction component 608. The prediction component 608 may have access to data 610, which may comprise one or more indications of one or more correlations between one or more variables and one or more states. The prediction component 608 may be configured to predict a state of a parking location based at least in part on a correlation between one or more variables and a possible state of the parking location. In one example, prediction component 608 may receive variable set 602, which may comprise Variable A 604 and Variable C 606. Prediction component 608 may access data 610 and search for an indication of (e.g., a correlation corresponding to) Variable A and/or Variable C (e.g., where a correlation may correspond to Variable A and Variable C individually, or may correspond to a combination of Variable A and Variable C). In the example, prediction component 608 may determine that an indication of a set comprising Variable A and Variable C in data 610 is associated with a state identified as State4. Prediction component 608 may therefore determine a prediction 612, which may comprise State4. It may be appreciated that the prediction 612 may indicate that for an example parking location associated (e.g., based upon data 610) with Variable A (e.g., physical proximity to an airport) and Variable C (e.g., temporal proximity to New Years Day), a state of State4 (e.g., vacant, occupied, etc.) may be predicted.

One or more systems and/or techniques are further described herein for removing (e.g., unreliable) variables from a set of variables that may, for example, be used to predict a parking state of a given location. A set of variables comprising a first variable and a second variable may be received. The first variable may be associated with a first parking location, and the second variable may be associated with a second parking location (e.g., where the first location may or may not be the same location as the second location). The first variable may be compared (e.g., using one or more statistical methods) to the second variable. Based on the comparison, the second variable may be removed from the set of variables (e.g., due to a difference between the first variable and the second variable). For example, the second variable may be removed in response to a determination that the second variable indicates that the second parking location is open at one or more times while the first variable indicates that the first parking location is occupied at the one or more times. In an example, multiple variables may be compared where respective variables are indicative of sensor readings, for example. Where multiple variables are indicative of change over time (e.g., parking spots becoming available and then unavailable, etc.), a particular variable that does not indicate change over time may be regarded as corresponding to a sensor that is no longer functioning properly, for example. For example, a sensor that uses a laser and/or other technology to sense the presence and/or absence of a vehicle in a parking spot may need to be repaired, replaced, etc. if the sensor does not indicate that a state of the parking spot does not fluctuate between occupied and unoccupied over time, whereas other sensors do indicate such a state change. After the second variable is removed from the set of variables, a correlation may be modeled between the set of variables and one or more states associated with the first parking location.

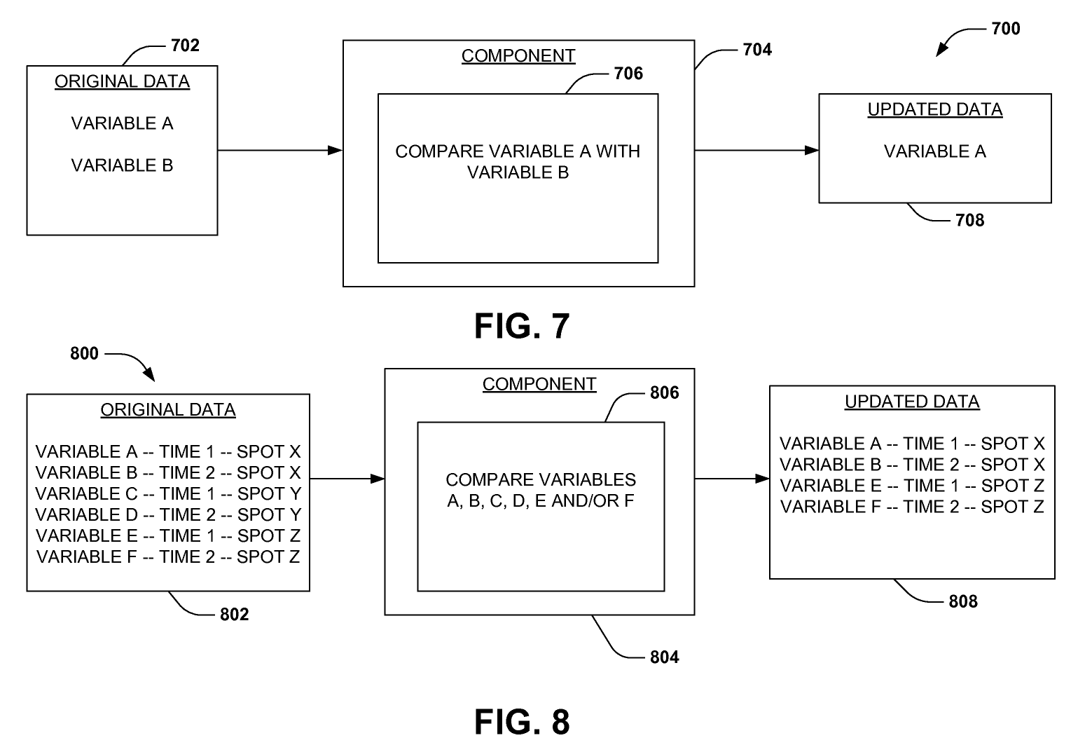

FIG. 7 illustrates an example of a system 700 configured for removing a variable from a set of variables. The system may comprise a component 704 configured to compare data, variables, etc. The component may receive original data 702. The original data 702 may, for example, comprise at least an indication of Variable A and Variable B. Upon receiving the original data 702, the component 704 may compare 706 Variable A with Variable B (e.g., and/or any other variables comprised in the original data 702). Based on the comparison 706, the component 704 may remove Variable B from the original data 702, and provide for updated data 708, which may comprise Variable A and not comprise Variable B. It may be appreciated that the updated data 708 may indicate that based upon the comparison 706, the component 704 determined that Variable B was unreliable, and therefore did not include Variable B in the updated data 708.

FIG. 8 illustrates an example of a system 800 configured for removing a variable from a set of variables. The system may comprise a component 804 configured to compare data, variables, etc. The component may receive original data 802. The original data 802 may, for example, comprise at least an indication of Variable A, Variable B, Variable C, Variable D, Variable E and Variable F. Each variable may, for example, correspond to a sensor, a time, weather, a (e.g., physical) proximity to a location, and/or a (e.g., temporal) proximity to an event, among other things, where each Variable may or may not correspond to the same variable (e.g., Variable A may correspond to a weather condition whereas Variable B and Variable C may correspond to a particular holiday (e.g., Independence Day)). Each variable may additionally, for example, be associated with a time (e.g., Time1 and/or Time2 (e.g., where Time1 and Time2 may or may not be the same time)), and a parking spot (e.g., Spot X, Spot Y, and/or Spot Z (e.g., where Spot X, Spot Y and/or Spot Z may or may not be the same spot)). Upon receiving the original data 802, the component 804 may compare 806 one or more combinations of Variable A, Variable B, Variable C, Variable D, Variable E and/or Variable F (e.g., and/or any other variables comprised in the original data 802). Based on the comparison 806, the component 804 may remove Variable C and Variable D from the original data 802, and provide for updated data 808, which may comprise Variable A, Variable B, Variable E and Variable F, but not comprise Variable C and Variable D. It may be appreciated that the updated data 808 may indicate that based upon the comparison 806, the component 804 determined that Variable C and Variable D were unreliable, and were therefore not included in the updated data.

In one example, the variables may correspond to data obtained from a first sensor, a second sensor, and a third sensor associated with Spot X, Spot Y, and Spot Z, respectively. In the example, Variable A may indicate sensor data pertaining to Spot X that was obtained by the first sensor at Time 1, Variable B may indicate sensor data pertaining to Spot X that was obtained by the first sensor at Time 2, Variable C may indicate sensor data pertaining to Spot Y that was obtained by the second sensor at Time 1, Variable D may indicate sensor data pertaining to Spot Y that was obtained by the second sensor at Time 2, Variable E may indicate sensor data pertaining to Spot Z that was obtained by the third sensor at Time 1 and Variable F may indicate sensor data pertaining to Spot Z that was obtained by the third sensor at Time 2. A comparison of Variable A and Variable B (e.g., to one another and/or to Variable C, Variable D, Variable E and/or Variable F) may indicate a change in sensor data obtained by the first sensor between Time 1 and Time 2. Similarly, a comparison of Variable E and Variable F (e.g., to one another and/or to Variable A, Variable B, Variable C and/or Variable D) may indicate a change in sensor data obtained by the third sensor between Time 1 and Time 2. However, a comparison of Variable C and Variable D (e.g., to one another and/or to Variable A, Variable B, Variable E and/or Variable F) may indicate no (e.g., or little and/or insignificant) change in sensor data obtained by the second sensor between Time 1 and Time 2. In the example, based upon the comparisons, a determination may be made that the second sensor is unreliable, not functioning, etc. (e.g., since related and/or nearby sensors sensed a change over time while the second sensor did not). To mitigate the effect of unreliable sensor data (e.g., upon a prediction of a state of a parking location), the second sensor and/or data associated with the second sensor (e.g., Variable C and Variable D) may be removed (e.g., from updated data used to perform a prediction of a state). It may be appreciated that a removed sensor and/or removed data associated with the removed sensor may later be re-entered into the updated data (e.g., responsive to a manual override, a determination that the removed sensor is reliable, etc.). An identification of unreliable data, a malfunctioning sensor, etc. may trigger an order to investigate the same (e.g., dispatch a technician to repair, replace, etc. the sensor).

One or more systems and/or techniques are further described herein for providing a map indicative of one or more parking locations. A map may be provided and may comprise one or more representations of one or more parking locations. A parking location that is determined and/or predicted to be (e.g., more likely to be) occupied may be displayed in a manner that distinguishes it from a parking location that is determined and/or predicted to be (e.g., more likely to be) vacant. At least some of the one or more representations of one or more parking locations may be marked with one or more indicators. In one example, a first indicator corresponding to a first parking location may, for example, comprise a first color (e.g., red), and a second indicator corresponding to a second parking location may comprise a second color (e.g., blue). In the example, the first color may indicate that the first parking location is determined to be more likely to be available (e.g., not occupied) than the second parking location (e.g., at an expected time of arrival). It may be appreciated that a parking location (e.g., represented on a map) may correspond to a single parking spot, one or more street-side parking spots, a parking lot comprising one or more parking spots, and/or a parking garage comprising one or more parking spots, among other things, for example. An indicator marking a parking location comprising more than one parking spot (e.g., a parking lot, a parking garage, etc.) may represent a number of parking spots that are (e.g., determined to be via a sensor, predicted to be, etc.) occupied and/or available, and/or may represent a proportion of parking spots that are (e.g., determined to be via a sensor, predicted to be, etc.) occupied and/or available. For example, a green indicator may be used to represent the availability of 80% of the parking spots in a parking garage (e.g., only 20% full). Alternatively, an indicator marking a parking location comprising more than one parking spot may represent a likelihood that one or more parking spots (e.g., a single parking spot, some of the parking spots and/or all of the parking spots) are available. For example, a red indicator may be used to represent a low likelihood of availability of any parking spots in a parking garage.

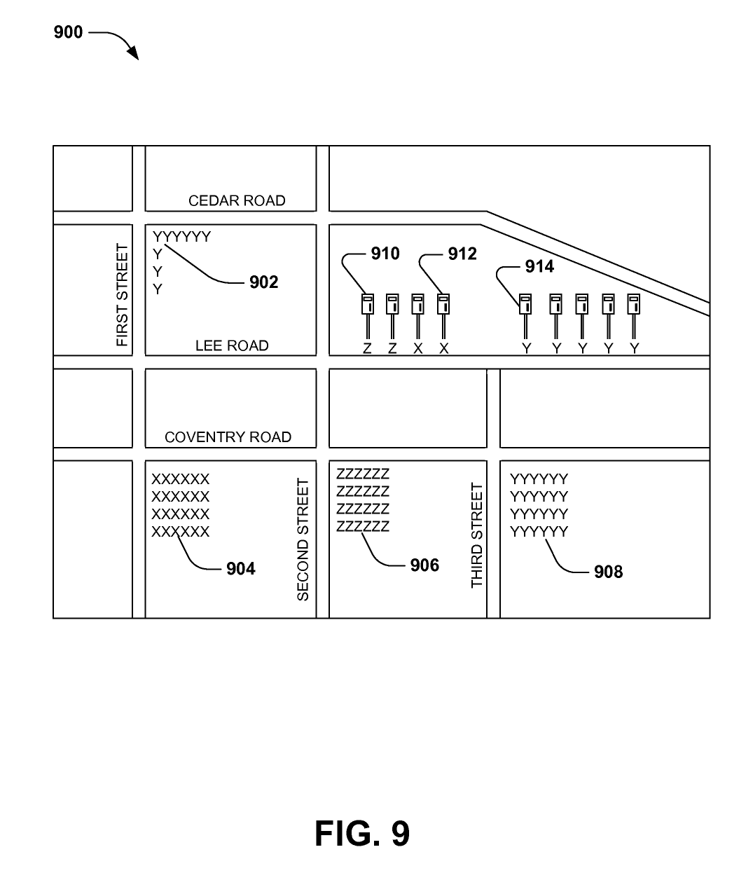

FIG. 9 illustrates an example 900 of a map. The map may comprise a representation of one or more paths (e.g., for driving), such as First Street, Second Street, Third Street, Cedar Road, Lee Road and Coventry Road. The map may further comprise representations of parking locations such as, for example, street-side parking locations 902, parking venues (e.g., comprising a parking lot, a parking garage, etc.) 904, 906 and 908, and/or metered street-side parking locations 910, 912 and 914. One or more representations of parking locations comprised in the map may be marked with one or more indicators. An indicator marking a representation of a parking location may, for example, indicate a likelihood of the parking location being available (e.g., vacant and/or not occupied) and/or unavailable (e.g., occupied). Representations of parking locations may, for example, be marked by indicators comprising the letters X, Y and Z, where X indicates a first (e.g., high) likelihood of availability, Y indicates a second (e.g., medium) likelihood of availability, and Z indicates a third (e.g., low) likelihood of availability.

In one example, the representation of the respective street-side parking locations 902 may be marked with the letter Y, which may indicate that there is a medium likelihood of the respective street-side parking locations 902 being available. The representation of parking venue 904 may be marked with one or more instances of the letter X, which may indicate that there is a high likelihood of one or more spots in the parking venue 904 being available, and the representation of parking venue 906 may be marked with one or more instances of the letter Z, which may indicate that there is a low likelihood of one or more spots in the parking venue 906 being available. The representation of parking venue 908 may be marked with one or more instances of the letter Y, which may indicate that there is a medium likelihood of one or more spots in the parking venue 908 being available. Additionally, the representation of the respective metered street-side parking locations 910 may be marked with the letter Z, the representation of the respective metered street-side parking locations 912 may be marked with the letter X, and the representation of the respective metered street-side parking locations 914 may be marked with the letter Y.

In one embodiment, a representation of a parking location comprising a plurality of parking spots may be marked by a single indicator. The single indicator may, for example, be based on an average of data and/or predictions associated with the plurality of parking spots. A map may be indicative of a likelihood of availability of one or more parking locations at a current time (e.g., real-time), and/or may be representative of a prediction of a likelihood of availability of one or more parking locations at a future time (e.g., an expected time of arrival). A map comprising one or more indicators associated with colors may, for example, comprise a heat map. It may be appreciated, for example, that if the map of example 900 was modified to comprise a heat map, the letter X could be replaced with a first color (e.g., red), the letter Y could be replaced with a second color (e.g., green), and the letter Z could be replaced with a third color (e.g., blue). Additionally and/or alternatively, a heat map (e.g., comprising a representation of a parking garage) may indicate that one or more parking spots located within a specified distance of an elevator may be associated with a lower likelihood of availability than one or more parking spots located further than the specified distance from the elevator, for example. Similarly, a heat map (e.g., comprising a representation of a parking garage) may indicate that one or more parking spots located within a specified number of levels of a main level may be associated with a lower likelihood of availability than one or more parking spots located more than the specified number of levels away from the main level, for example.

In one example, a map may indicate a difference between a predicted likelihood of availability of a parking location (e.g., which may be based on data received in real-time from a sensor) with an expected availability. In the example, if the predicted likelihood of availability of a parking location (e.g., based on a sensor) indicates that there is a high likelihood of the parking location having one or more available parking spots, but historical data indicates that the parking location rarely has one or more available parking spots, the map may comprise a second indicator that may, for example, notify a user (e.g., with a warning) that the predicted likelihood of availability is inconsistent with the historical data. The map may also, for example, display to the user a third indicator indicating one or more variables used to determine the predicted likelihood of availability of the parking location that may be inconsistent with variables associated with the historical data. In an example, a user may be able to choose and/or modify one or more of the variables used to predict a likelihood of availability (e.g., choose to predict based on a particular weather condition instead of and/or in addition to a specified holiday) and/or a user may be able to choose and/or modify one or more of the variables of historical data used to predict a likelihood of availability.

It may be appreciated that at least some of the aforementioned systems and/or methods may be at least partially used to predict a state that does not merely correspond to availability and/or unavailability of a parking location. In one example, a state of a parking location (e.g., and/or geographical area) may be associated with risk. In the example, the risk may be a risk of crime (e.g., break-ins on residential buildings, break-ins on commercial buildings, break-ins into vehicles, crimes against a person, etc.). The risk may, for example, be predicted based on an aggregation of data associated with crime. A map comprising representations of one or more parking locations may, for example, mark one or more representations of the one or more parking locations based on risk associated and/or predicted with the respective one or more parking locations (e.g., and/or a nearby geographical area). The map may be configured to mark different levels of risk with different colors and/or icons, among other things. Alternatively, the map may be configured to merely show parking locations below a certain risk level, above a certain risk level, and/or within a certain range of risk levels (e.g., and not show other parking locations).

In one embodiment, a map may display parking locations based upon cost. For example, a map may merely display parking locations below a certain cost, above a certain cost, and/or within a certain range of costs. In an example, cost may be associated with or consider risk (e.g., risk of car being stolen, vandalized, etc.). For example, a user may be willing to pay more for a parking spot that is considered to be associated with less risk than a parking spot that may be considered to be more risky or less safe. In an example, one or more indicators for a parking spot may thus reflect risk or a level of risk associated with a parking spot. A map may (e.g., merely) display parking locations that are within a selected distance of a destination (e.g., that a user is driving towards). A map may also display and/or hide one or more parking locations based on (e.g., current and/or predicted) weather conditions. For example, if current and/or predicted weather is associated with rain and/or snow, covered parking locations (e.g., parking garages, etc.) may be displayed, while uncovered parking locations (e.g., street-side parking locations, etc.) may not be displayed. In another example, a map may merely display one or more parking locations that meet one or more (e.g., current and/or predicted) traffic conditions. The one or more traffic conditions may, for example, be associated with one or more paths to one or more destinations. Directions may be provided to a user for one or more routes to a destination that are determined to involve driving the least distance, driving for the least amount of time, and/or waiting for a parking location for the least amount of time.

In another embodiment, a map may merely display one or more locations that are predicted to have one or more parking locations (e.g., and/or a number of parking spots) available, and/or hide (e.g., from display) one or more locations that are predicted not to have one or more parking locations (e.g., and/or a number of parking spots) available. For example, a user of the map may desire to visit a location of Famous Coffee Shop. The user may, for example, request the map to display one or more locations of Famous Coffee Shop (e.g., and/or directions to the one or more locations). The map may be configured, for example, to merely display one or more locations of Famous Coffee Shop that are predicted to have one or more parking locations (e.g., and/or a threshold number of parking spots) available (e.g., within a specified distance, etc.). Stated differently, the map may be configured to not display one or more locations of Famous Coffee Shop that are predicted to not have one or more parking locations (e.g., and/or a threshold number of parking spots) available (e.g., within a specified distance, etc.). In one example, the map may be configured to display and/or hide one or more locations of Famous Coffee Shop based on whether the locations are associated with one or more parking locations that meet a threshold likelihood of availability.

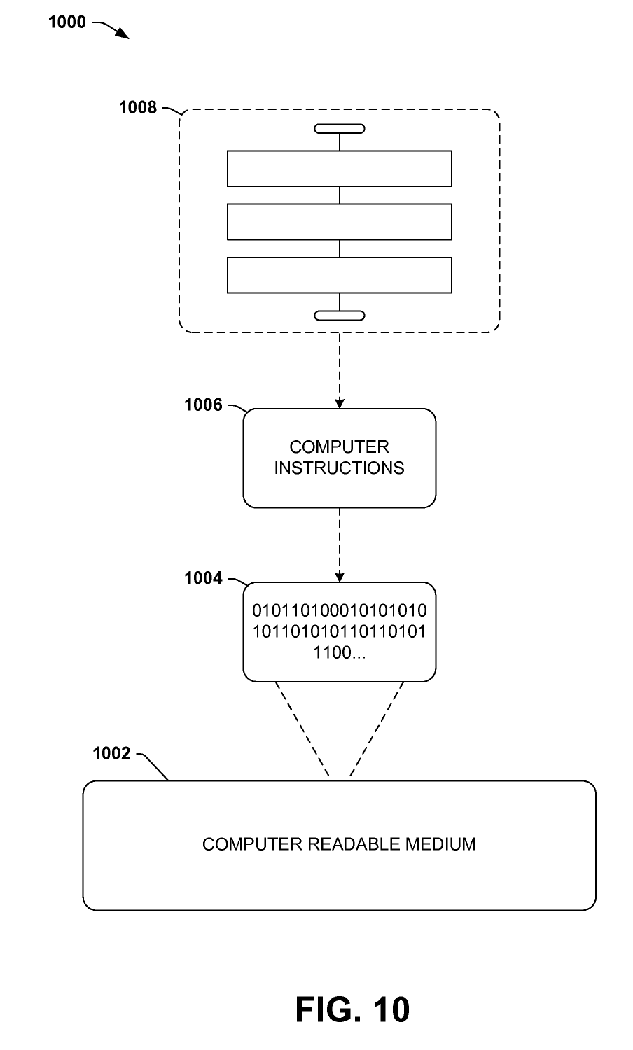

Still another embodiment involves a computer-readable medium comprising processor-executable instructions configured to implement one or more of the techniques presented herein. An exemplary computer-readable medium that may be devised in these ways is illustrated in FIG. 10, wherein the implementation 1000 comprises a computer-readable medium 1002 (e.g., a CD-R, DVD-R, or a platter of a hard disk drive), on which is encoded computer-readable data 1004. This computer-readable data 1004 in turn comprises a set of computer instructions 1006 configured to operate according to one or more of the principles set forth herein. In one such embodiment 1000, the processor-executable computer instructions 1006 may be configured to perform a method 1010, such as at least some of the exemplary method 100 of FIG. 1, and/or at least some of the exemplary method 200 of FIG. 2, for example. In another such embodiment, the processor-executable instructions 1006 may be configured to implement a system, such as at least some of the exemplary system 500 of FIG. 5, at least some of the exemplary system 600 of FIG. 6, at least some of the exemplary system 700 of FIG. 7, and/or at least some of the exemplary system 800 of FIG. 8, for example. Many such computer-readable media 1002 may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

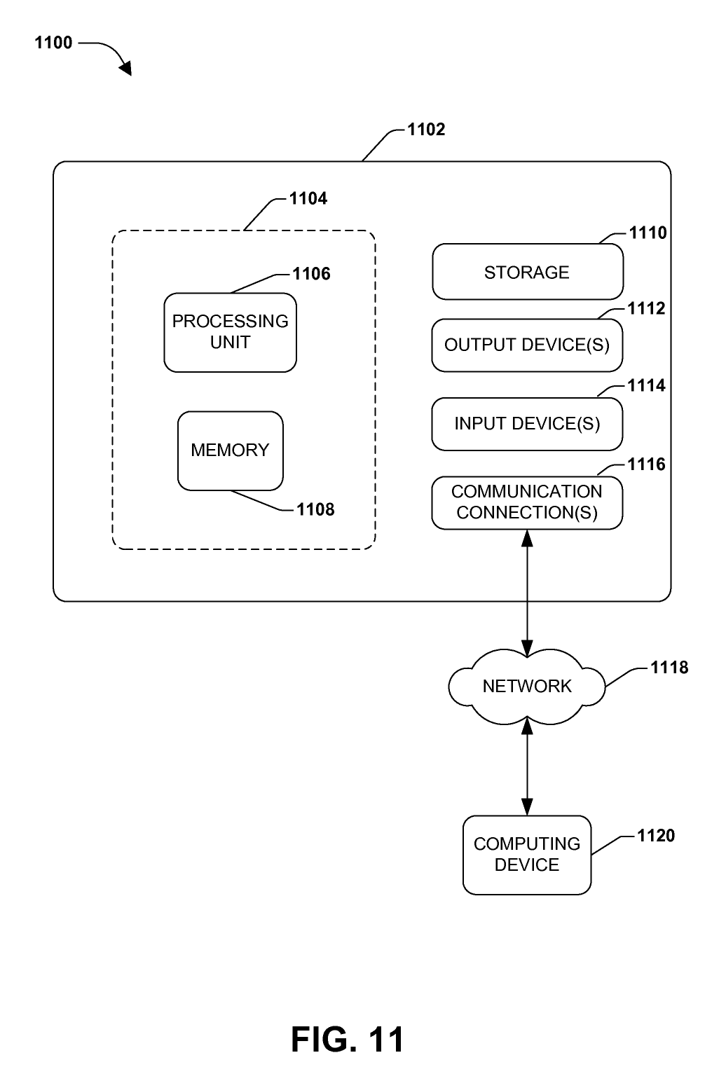

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1100 comprising a computing device 1102 configured to implement one or more embodiments provided herein. In one configuration, computing device 1102 includes at least one processing unit 1106 and memory 1108. Depending on the exact configuration and type of computing device, memory 1108 may be volatile (such as RAM, for example), non-volatile (such as ROM, flash memory, etc., for example), or some combination of the two. This configuration is illustrated in FIG. 11 by dashed line 1104.

In other embodiments, device 1102 may include additional features and/or functionality. For example, device 1102 may also include additional storage (e.g., removable and/or non-removable) including, but not limited to, magnetic storage, optical storage, and the like. Such additional storage is illustrated in FIG. 11 by storage 1110. In one embodiment, computer readable instructions to implement one or more embodiments provided herein may be in storage 1110. Storage 1110 may also store other computer readable instructions to implement an operating system, an application program, and the like. Computer readable instructions may be loaded in memory 1108 for execution by processing unit 1106, for example.

The term “computer readable media” as used herein includes computer storage media. Computer storage media includes volatile and nonvolatile, removable and non-removable media implemented in any method or technology for storage of information such as computer readable instructions or other data. Memory 1108 and storage 1110 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1102. Any such computer storage media may be part of device 1102.

Device 1102 may also include communication connection(s) 1116 that allows device 1102 to communicate with other devices. Communication connection(s) 1116 may include, but is not limited to, a modem, a Network Interface Card (NIC), an integrated network interface, a radio frequency transmitter/receiver, an infrared port, a USB connection, or other interfaces for connecting computing device 1102 to other computing devices. Communication connection(s) 1116 may include a wired connection or a wireless connection. Communication connection(s) 1116 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1102 may include input device(s) 1114 such as keyboard, mouse, pen, voice input device, touch input device, infrared cameras, video input devices, and/or any other input device. Output device(s) 1112 such as one or more displays, speakers, printers, and/or any other output device may also be included in device 1102. Input device(s) 1114 and output device(s) 1112 may be connected to device 1102 via a wired connection, wireless connection, or any combination thereof. In one embodiment, an input device or an output device from another computing device may be used as input device(s) 1114 or output device(s) 1112 for computing device 1102.

Components of computing device 1102 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1102 may be interconnected by a network. For example, memory 1108 may be comprised of multiple physical memory units located in different physical locations interconnected by a network.

Those skilled in the art will realize that storage devices utilized to store computer readable instructions may be distributed across a network. For example, a computing device 1120 accessible via a network 1118 may store computer readable instructions to implement one or more embodiments provided herein. Computing device 1102 may access computing device 1120 and download a part or all of the computer readable instructions for execution. Alternatively, computing device 1102 may download pieces of the computer readable instructions, as needed, or some instructions may be executed at computing device 1102 and some at computing device 1120.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B or the like generally means A or B or both A and B.

Although the disclosure has been shown and described with respect to one or more implementations, equivalent alterations and modifications will occur to others skilled in the art based at least in part upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method, comprising:
receiving a modeling variable associated with a first parking location; and
modeling a correlation between the modeling variable and a possible state of the first parking location.

2. The method of claim 1, comprising receiving a state of the first parking location given the modeling variable.

3. The method of claim 1, comprising predicting a state of a second parking location based at least in part on the modeled correlation.

4. The method of claim 3, comprising receiving a predicting variable, the predicting based at least in part on the predicting variable.

5. The method of claim 1, the received modeling variable based at least in part on one or more of:
real-time data from a sensor associated with the first parking location;
at least one of a time, a day, a week, a month, or a year associated with a parking state prediction;
a weather condition;
a physical proximity to one or more locations; or
a temporal proximity to one or more events.

6. A method, comprising:
predicting a state of a parking location based at least in part on a correlation between a variable and a possible state of the parking location.

7. The method of claim 6, the variable corresponding to one or more vehicles driving in an area near the parking location.

8. The method of claim 7, the variable indicative of at least some of the one or more vehicles driving for a period of time greater than a first threshold.

9. The method of claim 7, the variable indicative of at least some of the one or more vehicles driving past a same location more than a threshold number of times.

10. The method of claim 6, the predicted state associated with a time after the predicting.

11. The method of claim 6, the state corresponding to either vacant or occupied.

12. The method of claim 6, the parking location corresponding to a parking venue comprising a plurality of parking locations, the predicted state of the parking location indicative of at least one of:
a number of parking locations within the parking venue that are vacant; or
a proportion of parking locations within the parking venue that are vacant.

13. The method of claim 6, comprising predicting the state based upon a second variable when the variable is determined to be deficient.

14. The method of claim 13, the second variable comprising historical data.

15. The method of claim 14, the historical data comprising data associated with a time temporally before the predicting.

16. The method of claim 15, the historical data not comprising real-time data.

17. A system, comprising:
a prediction component configured to predict a state of a parking location based at least in part on a correlation between a variable and a possible state of the parking location.

18. The system of claim 17, the variable corresponding to one or more vehicles driving in an area near the parking location.

19. The system of claim 17, the prediction component configured to predict the state based upon a second variable when the variable is determined to be deficient.

20. A method, comprising:
receiving a set of variables comprising a first variable and a second variable, the first variable associated with a first parking location, the second variable associated with a second parking location;
comparing the first variable with the second variable;
removing the second variable from the set of variables based at least in part upon the comparing.

21. The method of claim 20, the comparing comprising determining that the second variable indicates that the second parking location is open at one or more times when the first variable indicates that the first parking location is occupied.

22. The method of claim 20, comprising after the removing, modeling a correlation between the set of variables and one or more states associated with the first parking location.

23. The method of claim 20, the comparing comprising using one or more statistical methods.

24. The method of claim 20, the set of variables comprising a third variable, the method comprising comparing the third variable to the second variable, the removing based at least in part upon the comparing the third variable to the second variable.

25. A method, comprising:
providing a map comprising one or more representations of one or more parking locations; and
marking at least some of the one or more representations with one or more indicators based on one or more of:
a likelihood of one or more parking spots comprised in at least one of the one or more parking locations being one or more of determined or predicted to be one or more of available or occupied;
a number of one or more parking spots comprised in at least one of the one or more parking locations that are one or more of determined or predicted to be one or more of available or occupied; or
a proportion of one or more parking spots comprised in least one of the one or more parking locations that are one or more of determined or predicted to be one or more of available or occupied.

26. The method of claim 25, the one or more indicators comprising one or more colors.

27. The method of claim 25, the one or more representations comprising a first representation of a first parking location and a second representation of a second parking location, the first representation marked with a first indicator, the second representation marked with a second indicator.

28. The method of claim 27, the first indicator associated with a greater likelihood of availability than the second indicator.

29. The method of claim 27, the first indicator associated with a first color, the second indicator associated with a second color different than the first color.

30. The method of claim 25, the one or more indicators associated with a likelihood of availability at an expected time of arrival.
